(19) United States
(12) Patent Application Publication
(10) Pub. No.: US 2025/0200212 A1
(43) Pub. Date: Jun. 19, 2025

(54) GENERATING KEYWORDS TO PRODUCE SYNTHETIC DOCUMENTS WHILE MAINTAINING DATA PRIVACY

(71) Applicant: Amazon Technologies, Inc., Seattle, WA (US)

(72) Inventors: Tal Wagner, Palo Alto, CA (US); Nina Mishra, Pleasanton, CA (US); Justin Yu-wei Chen, Mountain View, CA (US)

(73) Assignee: Amazon Technologies, Inc., Seattle, WA (US)

(21) Appl. No.: 18/539,107

(22) Filed: Dec. 13, 2023

(51) Int. Cl. G06F 21/62; G06F 16/33; G06F 16/383

(52) U.S. Cl. CPC G06F 21/6245; G06F 16/3347; G06F 16/383

(57) ABSTRACT

A service may generate keywords to produce synthetic documents, while maintaining data privacy for the original documents. A client may extract keyword sequences from locally stored documents, embed the keyword sequences into vectors, and generate a DP-KDE distribution based on the vectors. The DP-KDE distribution preserves data privacy for the original documents. The service receives the DP-KDE distribution, obtains a particular vector from the DP-KDE (e.g., based on a calculated score for the DP-KDE using random Gaussian completions), decodes the particular vector into a sequence of synthetic keywords, and uses the sequence of synthetic keywords to prompt an LLM to produce one or more synthetic documents.

### BACKGROUND

High quality data sets provide important insights that drive innovation across many different technological areas. The performance of machine learning models, for instance, may be highly dependent upon the quality of a given data set for training the machine learning model. Similarly, other analyses or data-driven solutions may depend upon access to high quality data sets to achieve good performance in real-world environments. Therefore, removing barriers to obtaining high quality data sets may be highly desirable.

### BRIEF DESCRIPTION OF THE DRAWINGS

FIG. 1 illustrates a logical block diagram of generating keywords to produce synthetic documents while maintaining data privacy, according to some embodiments.

FIG. 2 illustrates an example provider network that may implement a data management service that may implement techniques for generating keywords to produce synthetic documents while maintaining data privacy, according to some embodiments.

FIG. 3 illustrates a logical block diagram of interactions with privacy-preserving Kernel Density Estimate client application, according to some embodiments.

FIG. 4 illustrates a logical block diagram of interactions to generate keywords to produce synthetic documents while maintaining data privacy, according to some embodiments.

FIG. 5 illustrates a logical block diagram of generating keywords to produce synthetic documents while maintaining data privacy, according to some embodiments.

FIG. 6 illustrates a block diagram of example DP-KDE data structures for word-by-word sequence generation, according to some embodiments.

FIG. 7 illustrates a logical block diagram of generating keywords to produce synthetic documents that are used to train a model, according to some embodiments.

FIG. 8 illustrates a high-level flowchart of various methods and techniques to implement generating keywords to produce synthetic documents while maintaining data privacy, according to some embodiments, according to some embodiments.

FIG. 9 illustrates a high-level flowchart of various methods and techniques to implement generating a DP-KDE distribution, according to some embodiments.

FIG. 10 illustrates an example system to implement the various methods, techniques, and systems described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION OF EMBODIMENTS

Various techniques of generating keywords to produce synthetic documents while maintaining data privacy are described herein. A document (also referred to herein as a data set) may be generated in many different contexts. Documents may contain items (e.g., records or other data objects) with many different features (e.g., field values or other attributes). Some of these features may, for various reasons, be under privacy restrictions. Privacy restrictions may be imposed externally according to statutory or other regulatory schemes (e.g., preserving individual person privacy). Privacy restrictions may also be self-imposed for competitive or other context-specific reasons (e.g., to preserve sensitive organization information from competitors). Privacy restrictions may also impose retention policies, which may limit the amount of time data may be retained (e.g., no more than 2 years).

In spite of these privacy restrictions, there may be many beneficial reasons for sharing documents. For example, training of machine learning models often relies on large and/or numerous, accurate data sets (e.g., documents) in order to generate an accurate model. These models in turn power a variety of beneficial computerized functions, such as generation of artificial intelligence applications. However, in at least some cases, such models due to their design can output data that is substantially similar to data used to train the models. Accordingly, it may not be possible to train such models on data sets with privacy restrictions (e.g., preventing personally identifiable data of medical records). As a result, the data available to train these models is restricted, the accuracy of the models is reduced, and the resulting applications powered by such models are impaired. Synthetic documents can avoid this problem, insomuch as they can be created without private, confidential, or otherwise sensitive information. However, current methods for generation of synthetic documents often result in inaccuracies in the synthetic documents. This, in turn, results in inaccuracies in trained machine learning models.

The present disclosure provides solutions to the technical problem of creating accurate synthetic documents. For example, as discussed below, embodiments of the present disclosure can utilize kernel density estimates (KDEs or other types of density estimates) generated from original documents to enable creation of highly accurate synthetic documents without inclusion of private, confidential, or otherwise sensitive information from the original documents (e.g., patient name, patient identifier, date of birth, address for the patient). Moreover, embodiments of the present disclosure provide for generation of synthetic documents from original documents in a computationally efficient manner, reducing the computing resources required to create synthetic documents relative to past techniques. Accordingly, embodiments as disclosed herein provide for improvements in generation of synthetic documents and in computer-related technologies in general.

For example, synthetic data sets with high similarities to the data sets with privacy restrictions can be generated which do not violate enforced privacy restrictions. Instead, these synthetic data sets may be shared with entities to perform custom analysis or application development (e.g., training machine learning models and implementing applications based on the machine learning models, improving their performance with more and potentially higher quality data obtained from the synthetic data sets). Some synthetic data sets may be shared within an organization in order to facilitate cross organization learning or support other operations. Some synthetic data sets may be useful for broader communities to support, for example, scientific research, or support community-wide application development efforts. For at least these reasons, generating and sharing synthetic documents without violating privacy restrictions may offer many performance benefits for development in computer-related technologies.

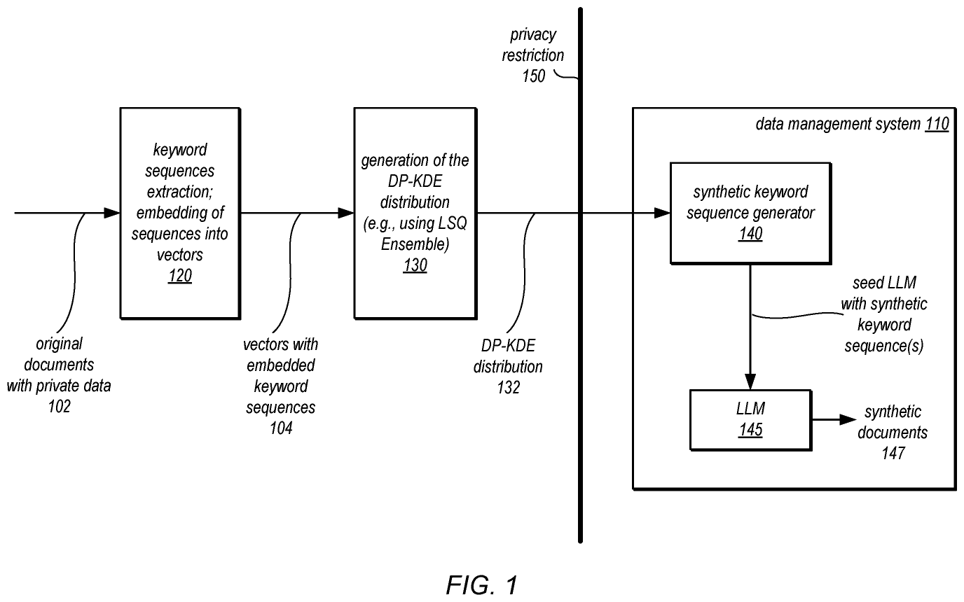

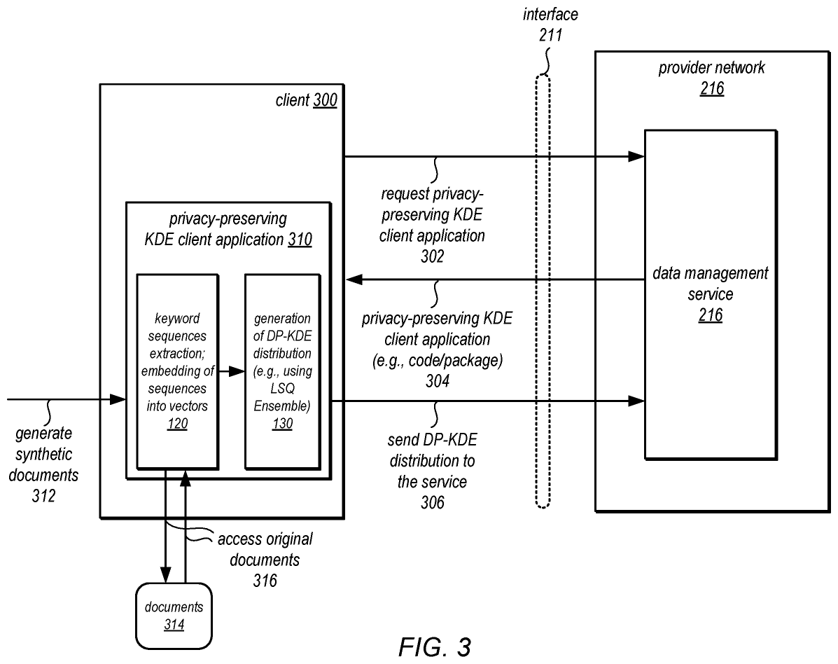

FIG. 1 illustrates a logical block diagram of generating keywords to produce synthetic documents while maintaining data privacy, according to some embodiments. As illustrated in FIG. 1, some data set owner, curator, or other data set source may have documents with private data (also referred to as “original documents”), which may be subject to some privacy restriction 150 (e.g., data of a medical document that identifies a patient). The private data in the documents may not be shared in violation of a privacy restriction. Accordingly, the documents owner, curator, or other data set source may generate the artifacts that preserve privacy and can be used to generate privacy-preserving KDEs by a recipient. As discussed below with regard to FIG. 3, a client application or other tool may be implemented, in various embodiments, to generate these artifacts (e.g., a differentially private (DP)-KDE distribution).

For example, any number of original documents 102 with data subject to a privacy limitation may be accessed and used to generate any number of corresponding vectors with embedded keyword sequences 104, as indicated at 120. As shown at 120, any number of different keyword sequences may be extracted from each document (e.g., “congestive heart failure” and “high blood pressure” and “cardiovascular disease” may be an example of a keyword sequence extracted from a document, where the keyword sequence includes the three different keywords within quotes). Note that a particular “keyword” may actually include any number of words. For example, “high blood pressure” includes three words and “cardiovascular disease” includes two words. At 120, for each document, the keyword sequences extracted from the document are embedded into a vector.

In some embodiments, a software application/tool (e.g., entity extraction tool) may be used that is configured to identify and/or extract each keyword for each of the documents. For example, the tool may identify and/or extract all keywords from a particular application domain (e.g., all possible diagnoses that exist in current medical literature, or all possible heart-related diagnoses that exist in current medical literature, which may include the three keywords above and many other keywords). In embodiments, the tool may provide a user interface that allows a user to specify the desired application domain, which will cause the tool to identify and/or extract all keywords from the specified application domain (in some embodiments, the user may select the desired application domain from among a list of any number of available application domains to choose from). To identify and/or extract keywords for an application domain, the tool may also determine any content (e.g., words, terms, etc.) that is not to be extracted because it is not relevant to the application domain (e.g., because the content is not a part of a “dictionary” of all terms from the application domain).

As shown, a DP-KDE distribution is generated 130 using the vectors generated at 120. For example, the DP-KDE distribution may be generated using locally sensitive quantization (LSQ) ensemble, as discussed below. The resulting DP-KDE distribution may allow data privacy for the documents 102 to be preserved (e.g., allow for keywords (also referred to as “synthetic keywords”) and synthetic documents to be generated without violating a data privacy restriction for the documents, as discussed below).

As indicated at 132, the DP-KDE distribution may be provided to a recipient, such as data management system 110 without violating privacy restriction 150. In some embodiments, the DP-KDE distribution may be stored (at least temporarily) by the data management system with privacy preserved and selectable for generating synthetic documents, or may be otherwise be shared directly with another service and/or remote client for generating synthetic keywords and/or synthetic documents (e.g., internally within a common organization that has privacy restrictions between different groups within the common organization).

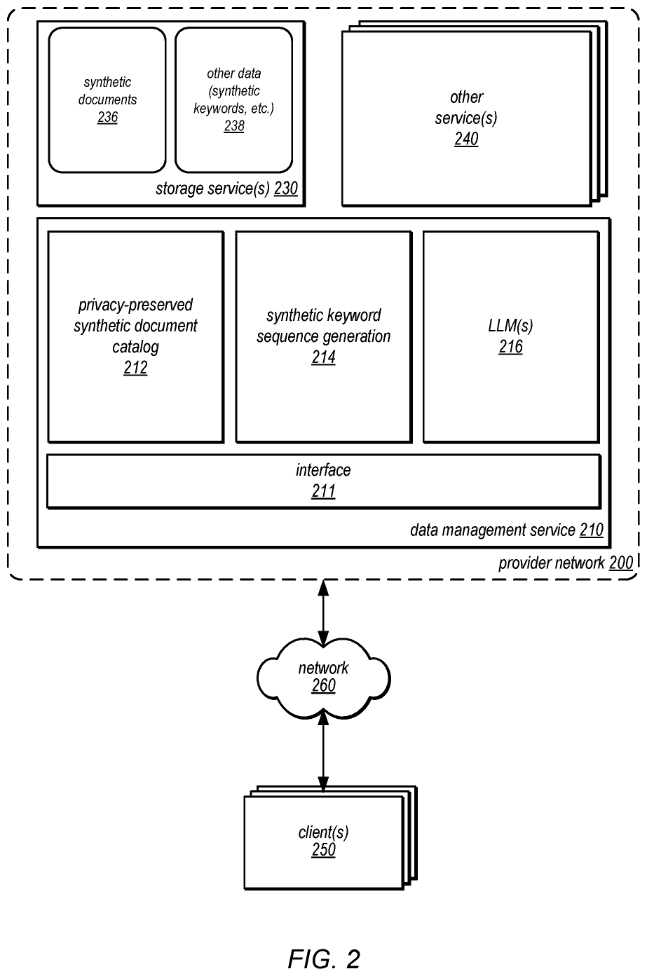

In embodiments, data management system 110 may be a recipient tool or other stand-alone application that can be used to generate a DP-KDE distribution. The tool can be provided by a data management service to recipients (e.g., in the same organization of a data set source but subject to the privacy restriction or to an external entity) so that the recipients may generate a DP-KDE distribution from documents received directly from a document source. In some embodiments, data management system 110 may be implemented as a service, like data management service 210 discussed below with regard to FIGS. 2-4, which may generate synthetic keywords and/or synthetic documents.

As indicated at 140, a synthetic keyword sequence generator 140 may generate any number of synthetic keyword sequences based on the received DP-KDE distribution. For example, the synthetic keyword sequence generator 140 may obtain a vector from the DP-KDE, wherein the vector includes a sequence of synthetic keywords embedded into the particular vector (the sequence of synthetic keywords does not violate a data privacy restriction of the client for the documents 102). The keyword sequence generator 140 then decodes the vector into a sequence of synthetic keywords.

The keyword sequence generator 140 may then prompt a large language model (LLM) 145 to produce any number of synthetic documents 147, wherein the LLM is seeded with the sequence of synthetic keywords to produce the synthetic documents 147 (e.g., seeding the LLM with the synthetic keyword sequences). The data management system 110 obtains the synthetic documents from the LLM. The data management system 110 obtains the synthetic documents from the LLM then stores the synthetic documents and/or sends the synthetic documents to an endpoint (e.g., to a remote client of the data management system 110 and/or to another service of the data management system 110 and/or to a storage location at the data management system 110). Note that although an LLM is used herein as an example of a synthetic text generator that generates synthetic documents by providing synthetic keyword sequences to it, in various embodiments any other type of synthetic text generator may be used instead of the LLM (e.g., a different type of model or any other type of algorithm/application that may take a keyword sequence as input and generate synthetic documents based on the keyword sequence input).

Please note that the previous description of generating keywords to produce synthetic documents while maintaining data privacy is a logical illustration and thus is not to be construed as limiting as to various other embodiments that may implement the above techniques.

This specification begins with a general description of a provider network that implements multiple different services, including a data management service, with techniques for generating keywords to produce synthetic documents while maintaining data privacy. Then various examples of the data management service, including different components/modules, or arrangements of components/module that may be employed as part of implementing the data management service are discussed. A number of different methods and techniques to implement techniques for generating keywords to produce synthetic documents while maintaining data privacy are then discussed, some of which are illustrated in accompanying flowcharts. Finally, a description of an example computing system upon which the various components, modules, systems, devices, and/or nodes may be implemented is provided. Various examples are provided throughout the specification.

FIG. 2 illustrates an example provider network that may implement a data management service that may implement techniques for generating keywords to produce synthetic documents while maintaining data privacy, according to some embodiments. Provider network 200 may be a private or closed system or may be set up by an entity such as a company or a public sector organization to provide one or more services (such as various types of cloud-based storage) accessible via the Internet and/or other networks to clients 250, in one embodiment. Provider network 200 (which may, in some implementations, be referred to as a “cloud provider network” or simply as a “cloud”) refers to a pool of network-accessible computing resources (such as compute, storage, and networking resources, applications, and services), which may be virtualized or bare-metal. Provider network 200 can provide convenient, on-demand network access to a shared pool of configurable computing resources that can be programmatically provisioned and released in response to customer commands. These resources can be dynamically provisioned and reconfigured to adjust to variable load. For example, in some embodiments, provider network 200 may implement various computing resources or services, such as object data management service 210, storage service(s) 230, and/or any other type of network-based services 240 (which may include a virtual compute service and various other types of storage, database or data processing, analysis, communication, event handling, visualization, data cataloging, data ingestion (e.g., ETL), and security services), in some embodiments.

The provider network 200 can be formed as a number of regions, where a region is a separate geographical area in which the cloud provider clusters data centers. Each region can include two or more availability zones connected to one another via a private high speed network, for example a fiber communication connection. An availability zone (also known as an availability domain, or simply a “zone”) refers to an isolated failure domain including one or more data center facilities with separate power, separate networking, and separate cooling from those in another availability zone. Preferably, availability zones within a region are positioned far enough away from one other that the same natural disaster should not take more than one availability zone offline at the same time. Customers can connect to availability zones of the provider network 200 via a publicly accessible network (e.g., the Internet, a cellular communication network). Regions are connected to a global network which includes private networking infrastructure (e.g., fiber connections controlled by the cloud provider) connecting each region to at least one other region. The provider network 200 may deliver content from points of presence outside of, but networked with, these regions by way of edge locations and regional edge cache servers. This compartmentalization and geographic distribution of computing hardware enables the provider network 200 to provide low-latency resource access to customers on a global scale with a high degree of fault tolerance and stability.

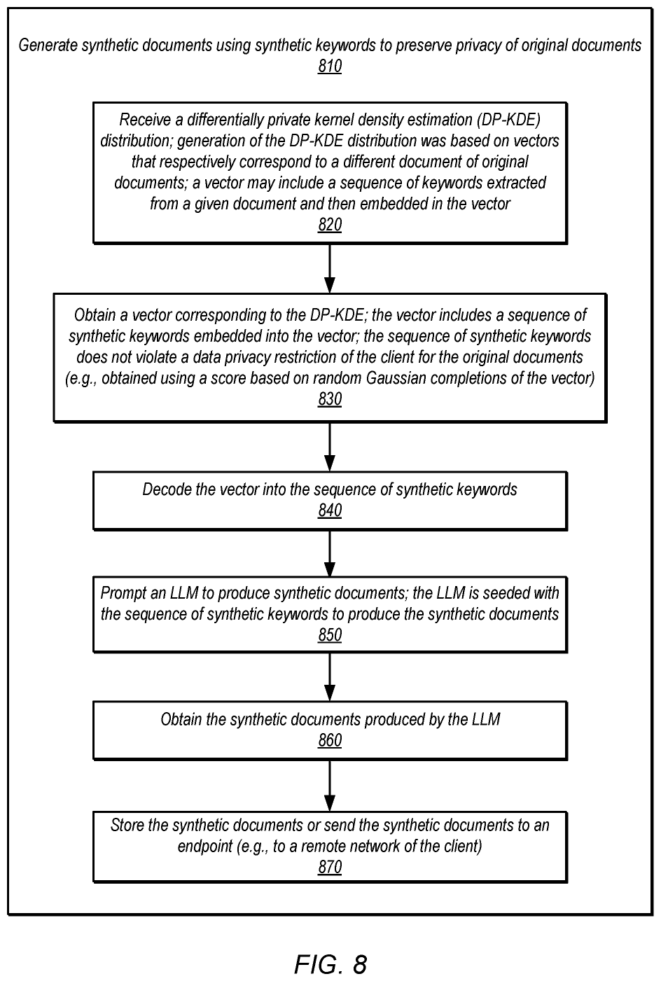

In various embodiments, the components illustrated in FIG. 2 may be implemented directly within computer hardware, as instructions directly or indirectly executable by computer hardware (e.g., a microprocessor or computer system), or using a combination of these techniques. For example, the components of FIG. 2 may be implemented by a system that includes a number of computing nodes (or simply, nodes), each of which may be similar to the computer system embodiment illustrated in FIG. 8 and described below, in one embodiment. In various embodiments, the functionality of a given system or service component (e.g., a component of machine learning search service 210 may be implemented by a particular node or may be distributed across several nodes. In some embodiments, a given node may implement the functionality of more than one service system component (e.g., more than one data store component).

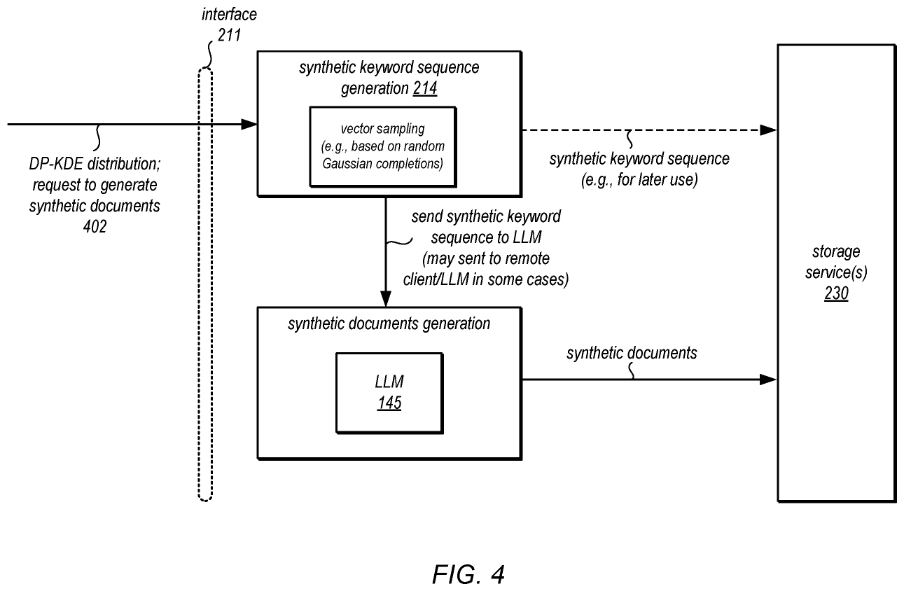

Data management service 210 may implement interface 211 to allow clients (e.g., client(s) 250 or clients implemented internally within provider network 200, such as a client application hosted on another provider network service like an event driven code execution service or virtual compute service) to send various requests to generate/obtain synthetic keywords and/or synthetic documents. For example, data management service 210 may implement interface 211 (e.g., a graphical user interface, programmatic interface that implements Application Program Interfaces (APIs) and/or a command line interface) may be implemented so that a client can request or submit various requests, as discussed below with regard to FIGS. 3-4.

Data management service 210 may dispatch different requests received via interface 211 to different components. For example, data management service 210 may implement privacy-preserved synthetic document catalog 212. In embodiments, privacy-preserved synthetic document catalog 212 may provide a search index or utilize other metadata or descriptive material for data sets to make available those data sets (e.g., documents) that can be explored by a client/user, and allow a user to select/download one or more of the synthetic documents to the client's remote network in order for them to train a model using the document(s).

In some embodiments, the privacy-preserved synthetic document catalog 212 may store different groups of synthetic documents, where each group of synthetic documents was generated from sampling keywords from a different DP-KDE. For example, one department of a hospital may generate synthetic documents based on sampling synthetic keywords from a DP-KDE that includes embedded keywords that describe heart-related health issues, whereas a different department may generate synthetic documents based on sampling synthetic keywords from a DP-KDE that includes embedded keywords that describe respiratory health issues. In embodiments, the catalog may store different DP-KDEs, allowing users/clients to generate synthetic documents based on sampling synthetic keywords from different DP-KDEs.

In various embodiments, data management service 210 may implement synthetic keyword sequences generation 214, as discussed in detail below with regard to FIG. 4, which may implement various sampling techniques using privacy-preserving KDEs to generate synthetic keyword sequences. In this way, synthetic documents may be generated using an LLM 216 that preserve data privacy for documents that cannot be shared directly due to privacy restrictions.

Data storage service(s) 230 may implement different types of data stores for storing, accessing, and managing data on behalf of clients 250 as a network-based service that enables clients 250 to operate a data storage system in a cloud or network computing environment. Data storage service(s) 230 may also store various data for data management service 210, including synthetic documents 236 (e.g., generated by one or more LLMs 216 and stored for various purposes, such as for data set retention, as training data sets, or for various other analyses) and/or other data 238 (e.g., synthetic keywords generated by synthetic keyword sequences generation 214).

Storage services 230 may include object or file data stores for putting, updating, and getting data objects or files, in some embodiments. For example, one data storage service 230 may be an object-based data store that allows for different data objects of different formats or types of data, such as structured data (e.g., database data stored in different database schemas), unstructured data (e.g., different types of documents or media content), or semi-structured data (e.g., different log files, human-readable data in different formats like JavaScript Object Notation (JSON) or Extensible Markup Language (XML)) to be stored and managed according to a key value or other unique identifier that identifies the object. In at least some embodiments, data storage service(s) 230 may be treated as a data lake. For example, an organization may generate many different kinds of data, stored in one or multiple collections of data objects in a data storage service 230. The data objects in the collection may include related or homogenous data objects, such as database partitions of sales data, as well as unrelated or heterogeneous data objects, such as image data files (e.g., digital photos or video files) audio files and web site log files. Data storage service(s) 230 may be accessed via programmatic interfaces (e.g., APIs) or graphical user interfaces.

Generally speaking, clients 250 may encompass any type of client that can submit network-based requests to provider network 200 via network 260, including requests for data management service 210 discussed below. For example, a given client 250 may include a suitable version of a web browser, or may include a plug-in module or other type of code module that can execute as an extension to or within an execution environment provided by a web browser. Alternatively, a client 250 may encompass an application such as an application that may make use of data management service 210 to implement various applications. For example, a client 250 may send a request to generate a privacy-preserving KDE value for a feature in a data set. In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 250 may be an application that can interact directly with provider network 200. In some embodiments, client 250 may generate network-based services requests according to a Representational State Transfer (REST)-style network-based services architecture, a document- or message-based network-based services architecture, or another suitable network-based services architecture. In some embodiments, a client 250 may provide access to provider network 200 to other applications in a manner that is transparent to those applications.

Clients 250 may convey network-based services requests (e.g., access requests to read or write data may be via network 260, in one embodiment. In various embodiments, network 260 may encompass any suitable combination of networking hardware and protocols necessary to establish network-based-based communications between clients 250 and provider network 200. For example, network 260 may generally encompass the various telecommunications networks and service providers that collectively implement the Internet. Network 260 may also include private networks such as local area networks (LANs) or wide area networks (WANs) as well as public or private wireless networks, in one embodiment. For example, both a given client 250 and provider network 200 may be respectively provisioned within enterprises having their own internal networks. In such an embodiment, network 260 may include the hardware (e.g., modems, routers, switches, load balancers, proxy servers, etc.) and software (e.g., protocol stacks, accounting software, firewall/security software, etc.) necessary to establish a networking link between given client 250 and the Internet as well as between the Internet and provider network 200. It is noted that in some embodiments, clients 250 may communicate with provider network 200 using a private network rather than the public Internet.

As noted herein, synthetic keyword sequences generation 214 may handle requests to facilitate the generation of synthetic keyword sequences and/or synthetic documents. FIG. 3 illustrates a logical block diagram illustrating interactions with privacy-preserving KDE client application, according to some embodiments. A client 300 may send a request for a privacy-preserving KDE client application 302 via interface 211. Privacy-preserving KDE generation 216 may provide the privacy-preserving KDE client application 310 (e.g., as an executable, library, or various other instructions for generating appropriate artifacts for privacy-preserving KDEs), as indicated at 304.

Privacy-preserving KDE client application 310 may implement the various techniques discussed herein (e.g., above with regard to FIG. 1) to generate a DP-KDE distribution. Privacy-preserving KDE client application 310 may implement an interface (e.g., graphical, programmatic, or command line) that specifies a request to generate synthetic documents (e.g., privatize documents for KDE estimation), as indicated at 312. Because privacy-preserving KDE client application 310 is deployed at client 300, it can access the documents, as indicated at 316 without violating a privacy restriction because client 300 may have legitimate access to documents 314 without violating a privacy restriction. In some embodiments, various features of the generation of the DP-KDE may be provided as part of the request, including various parameter values such as the method to be used for computing the DP-KDE distribution (e.g., Gaussian, LSQ Ensemble, or other supported distributions).

As indicated at 306, the DP-KDE distribution may be provided to data management service 216. In embodiments, a data store, catalog or other index may also be updated, in various embodiments, to include the DP-KDE distribution, the generated synthetic keyword sequences, and/or the generated synthetic documents. In some embodiments, requests (not illustrated) may be submitted via interface 211 to describe, annotate, or otherwise provide a description of the underlying documents/data set which may be used for facilitating search for synthetic documents in the catalog.

FIG. 4 illustrates a logical block diagram of interactions to generate keywords to produce synthetic documents while maintaining data privacy, according to some embodiments. As indicated at 402, a request to generate synthetic documents may be received via interface 211 at synthetic keyword sequence generation 214. In embodiments, the request may also include the DP-KDE distribution to be sampled. In some embodiments, the request may specify/identify the DP-KDE distribution to be sampled (for example, when the DP-KDE distribution was previously provided by the client or other client and stored by the service).

In embodiments, the request may specify various configuration information, such as a destination for documents, sampling controls or variables (e.g., which sampling technique and which items to sample in order to generate custom synthetic keyword sequences and/or synthetic documents that can, for example, increase the numbers of underrepresented items in the data set to address a lack of data). In some embodiments, the request to generate the synthetic documents may be made to publish the synthetic documents on behalf of the document source, curator, or owner in storage services so that data management service 210 (or another service of provider network 200) may sell or control access to or use of the synthetic data set, in some embodiments. In some embodiments, synthetic keyword sequence generation 214 may track the number of synthetic documents for a given underlying documents in order to evaluate whether a privacy budget for implementing differential privacy is not exceeded by generating multiple versions of a synthetic documents from a same underlying documents. In such embodiments, warnings or restrictions on creating additional synthetic documents may be enforced to ensure that privacy budgets for are not exceeded.

Synthetic data keyword sequence generation 214 may implement synthetic vector sampling (e.g., based on random Gaussian completions, as described herein) to obtain/select a synthetic vector from the DP-KDE distribution. As discussed in detail above with regard to FIG. 1, a synthetic keyword sequence may be obtained based on the synthetic vector and sent to the LLM 145 for synthetic documents generation (in some embodiments, the synthetic keyword sequence may be stored at storage service(s) 230 and sent to the LLM 145 at a later time for generation of synthetic documents). In embodiments, the synthetic documents may be sent to the client that sent the request to generate the synthetic documents and/or the synthetic documents may be stored at storage service(s) 230 for later retrieval by the client and/or other client(s).

In some embodiments, the synthetic keyword sequence may be sent to a remote client and/or LLM instead of the LLM 145 of the provider network. For example, a remote client that provided the DP-KDE distribution or another third-party remote client may receive the synthetic keyword sequence from the provider network (e.g., from the synthetic data keyword sequence generation 214) and may prompt an LLM at their own local network to generate synthetic documents bay seeding the LLM with the synthetic keyword sequence. Since the synthetic keyword sequence does not violate a data privacy restriction of the client, then synthetic keyword sequence can be transmitted through unsecure networks and/or to any remote clients without any risk of exposing private data that existed in the original documents.

Although FIGS. 2-4 have been described and illustrated in the context of a provider network implementing a data management service, the various components illustrated and described in FIGS. 2-4 may be easily applied to other combinations of systems or devices, as discussed above with regard to FIG. 1. As such, FIGS. 2-4 are not intended to be limiting as to other embodiments of generating keywords to produce synthetic documents while maintaining data privacy.

In embodiments, the notion of privacy called differential privacy (DP), is considered as the “gold standard” of privacy in machine learning. In some embodiments, an algorithm is differentially private if its output is not sensitive to the inclusion of exclusion of any single data record e.g., any single text document) in the input dataset (the input collection of text documents). In an embodiment, to define DP, let ϵ>0, and a randomized algorithm M that maps input datasets to a range of outputs O is called ϵ-differentially private (abbrev. ϵ-DP) if for every pair of datasets C, C′ that differ in a single data record and for every O⊂O:

Pr[M(C)∈O]≤e^{ϵ}Pr[M(C′)∈O]

LLMs are a type of machine learning (ML) technology, that are able to take a natural free text “prompt” requesting a particular output text (e.g., “write a medical record of a patient hospitalized for congestive heart failure”), and output high-quality natural text that meets the request.

In embodiments, seeding LLMs with keywords is an effective method for producing a large and diverse collection of synthetic text documents. For example, when prompting a state-of-the-art LLM to produce a collection of children's stories without keyword seeding, the stories in the collection may not be sufficiently different from each other. When prompts are seeded with a sequence of three keywords (a noun, a verb and an adjective) from a vocabulary typical of a toddler's, and the LLM is asked to incorporate those keywords into the story, the resulting stories may be of higher quality and diversity.

Let D be a “dictionary” of all terms from a particular application domain (for example, all possible diagnoses in the medical literature). These terms may be referred to as “keywords,” even though each term may be a key phrase containing several words (e.g., “congestive heart failure”). In embodiments, a neural embedding model is a mapping Emb: D→ [symbol] that maps each term to a point (called an embedding) in a high-dimensional geometric space [symbol] , such that the embeddings of semantically related terms are closer in Euclidean distance than the embeddings of semantically unrelated terms. For example, if w₁∈D is the term “congestive heart failure,” w₂∈D is “cardiovascular disease,” and w₃∈D is “knife wound”, then ∥Emb(w₁)−Emb(w₂)∥₂ would be small since both w₁ and w₂ are medical conditions related to the heart, while ∥Emb(w₁)−Emb(w₃)∥₂ would be larger since w₁ and w₃ are unrelated medical conditions.

In embodiments, high quality neural embeddings can be obtained by training neural networks. Importantly, they have the following key properties:
High dimensionality: The embedding dimension dis large (e.g., at least in the hundreds).
Normalization: The embeddings have unit norm, i.e., ∥Emb(w)∥₂=1 for every w∈D.

Kernel density estimation (KDE) is a method to fit a smooth distribution to a discrete set of points X in [symbol] . In the particular case of the Gaussian kernel, it uses the mixture of Gaussian distributions centered at each point in X. Formally, given X, the KDE at every point y∈ [symbol] is defined as

$${KDE}_{X} ( y ) = \frac{1}{\vert X \vert} {\sum }_{x ∈ X} {e}^{- {‖ x - y ‖}_{2}^{2}}$$

LSQ is a method for computing differentially private kernel density estimation (DP-KDE). Given a desired error tolerance α>0, the goal is to produce a differentially private estimate êₓ(y) for any point y∈ [symbol] that with high probability deviates from the true value KDE_{X}(y) by an additive error of at most α>0.

In embodiments, the solution for the case of the Gaussian kernel is based on Random Fourier Features and operates as follows:

The party holding the private dataset X performs:
Sample w˜N(0,1) and B˜Uniform(0,2π) and λ˜Laplace(\sqrt{2}/(ϵ|X|))
Compute

$$\hat{F} ← \frac{\sqrt{2}}{\vert X \vert} {\sum }_{x ∈ X} cos ( {ω}^{T} x + β ) + λ$$

Release Ê, ω, β. These values are DP and can be safely released externally.
   The party holding the query y∈ [symbol] computes êₓ(y)+\hat{F}·cos(ω^{T}y+β).

This procedure is invoked O(log(1/η)/α²) times, and the median of averages is taken and returned. The result is an ϵ-DP value that approximates KDE_{X} (y) up to an additive error of at most α with probability 1−η.

At a high level, embodiments build on the idea of seeding LLM prompts with keyword sequences. It may be challenging to ensure that those keyword sequences are private. To do so, keyword sequences extracted from the original dataset are embedded into high-dimensional embedding vectors as discussed above, and the private density estimation framework discussed above is used in order to generate new private sequences which are then used for seeding the LLM prompts (as discussed below).

Note that although a DP-KDE is used herein as an example of a differentially private density estimation (DP-DE) that allows for a private way to estimate density and to provide synthetic keyword sequences for synthetic document generation, in various embodiments any other type of DP-DE may be generated and/or used instead of a DP-KDE in order to perform any of the techniques described herein. For example, a histogram-based DP-DE distribution may be generated and/or used that allows for a private way to estimate density (e.g., by creating a histogram over the points and adding noise to the histogram). In various embodiments, a client may generate any type of DP-DE distribution over embedded vectors representing sequences of keywords that preserves privacy of the original documents. Any of the techniques described herein for a DP-KDE may be used for other types of DP-DEs (e.g., obtaining a vector from the DP-DE distribution, decoding the vector into a sequence of synthetic keywords, prompting a synthetic text generator with the sequence of synthetic keywords, etc.).

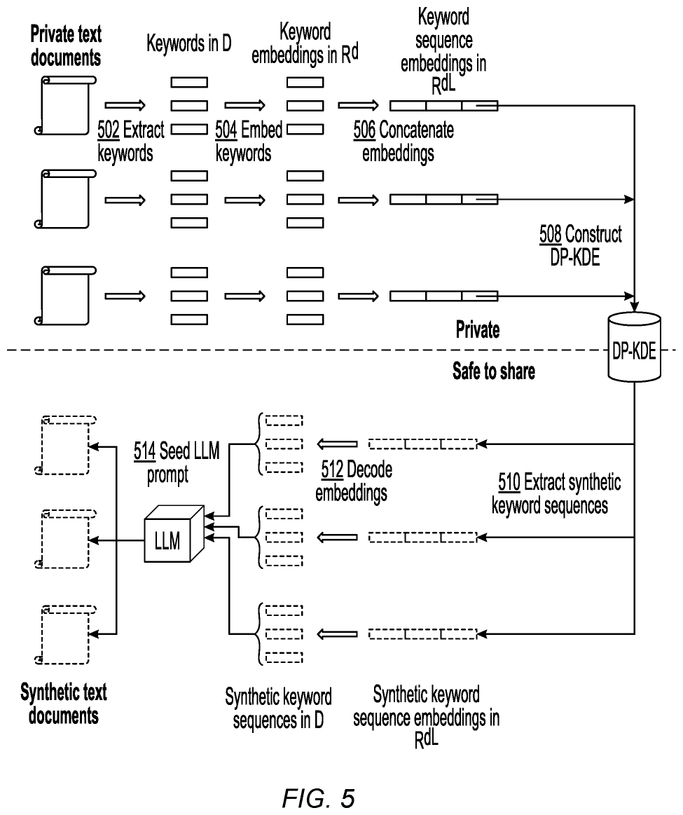

FIG. 5 illustrates a logical block diagram of generating keywords to produce synthetic documents while maintaining data privacy, according to some embodiments.

The input is a collection C of text documents (e.g., textual medical records kept by a hospital) and a dictionary D of all possible keywords in the domain (e.g., all possible medical diagnoses). The method proceeds as follows:
i. Extract from each document in C a sequence of L keywords from D that appear in it. (502)
ii. Embed each such sequence (ω₁, ω₂, . . . , ω_{L}) into a dL-dimensional vector given by the concatenation (Emb(ω₁), . . . , Emb(ω₂)), . . . , Emb(ω_{L}))∈ [symbol] . (504) (Recall that Emb(ω) is a unit-length embedding of ω in [symbol] .)
iii. Let X denote the collection of all those dL-dimensional vectors extracted from C. (506)
iv. Construct a DP-KDE distribution in R^{dL} over the set X. (508)
v. Choose a vector y∈ [symbol] with a high DP-KDE score. Decode it into a sequence of keywords (\hat{ω}₁, \hat{ω}₂, . . . , \hat{ω}_{L}). (510)
vi. Prompt an LLM to produce a text document of the desired form, seeded with the sequence of keywords (\hat{ω}₁, \hat{ω}₂, . . . , \hat{ω}_{L}). (512)

In embodiments, steps v (510) and vi (512) above can be repeated many times to output a large and diverse collection of synthetic text documents. The DP component in step iv (508) ensures those output documents are private. The choice of y∈ [symbol] in step v (510) can be by the highest scoring vectors (e.g., selected form a group of highest scoring vectors), or by sampling vectors with probability proportional to their DP-KDE scores.

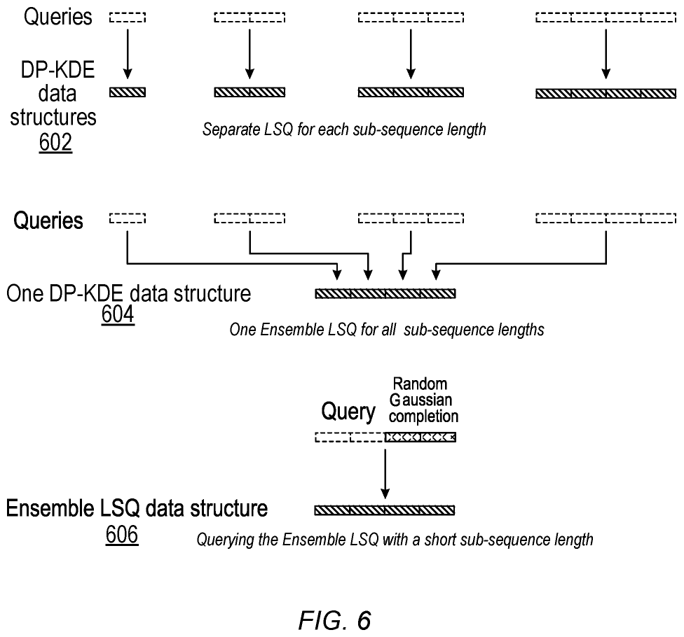

FIG. 6 illustrates a block diagram of example DP-KDE data structures for word-by-word sequence generation, according to some embodiments.

The LSQ technique described above privately estimates the DP-KDE score of any given sequence, but does not generate new sequences proportionally to their scores. A nave solution is to enumerate over all possible |D|^{L} sequences and estimate the DP-KDE score of each. However, this is infeasible due to the large number of sequences. In most applications the keyword dictionary D has size of order at least 10⁴, rendering even sequences of just L=3 keywords too many to enumerate over in a reasonable time.

Instead of using a different LSQ in every iteration of the word-by-word sequence generation procedure, a technique referred to herein as LSQ Ensemble may be used, resulting in a single data structure 604, 606 that can be used across all iteration and all sub-sequence lengths (instead of using multiple data structures 602).

The solution combines the Gaussian kernel LSQ described above with random Gaussian completions. It works as follows:
The party that holds the full private sequences X⊂R^{dL} performs:
Sample the following:

$${ω}_{1} , … , {ω}_{L} \sim N ( 0 , \frac{2}{L} \cdot {d}_{} )$$

$${r}_{2} , … , {r}_{L} \sim N ( 0 , \frac{1}{d} \cdot {d}_{} )$$

(This is the random Gaussian completion)
B˜Uniform[0,2π)
λ˜Laplace(\sqrt{2}/(ϵ|X|))
Compute

$$\hat{F} ← \frac{\sqrt{2}}{\vert X \vert} {\sum }_{( {x}_{1} , … , {x}_{L} ) ∈ X} cos ( {\sum }_{i = 1}^{L} {ω}_{i}^{T} {x}_{i} + β ) + λ$$

Release \hat{F}, ω₁, . . . , ω_{L}, r₂, . . . , r_{L}, β. These values are ϵ-DP and can safely be released externally.
   To estimate the DP-KDE score of a sequence y=(y₁, . . . , yₗ) of any length l∈{1, . . . , L}, compute and return

$${\hat{e}}_{X}^{( l )} ( y ) ← \hat{F} \cdot cos ( {\sum }_{i = 1}^{l} {ω}_{i}^{T} {y}_{i} + {\sum }_{i = l + 1}^{L} {ω}_{i}^{T} {r}_{i} + β )$$

The random Gaussian completions (i.e., the rᵢ's) come into play in the second sum inside the cosine, Σᵢ₌ₗ₊₁^{K}ωᵢ^{T}rⁱ making up for the missing xᵢ's in the query. As usual, the procedure is repeated several times with fresh random samples, and the median of averages is taken to ensure the desired error is attained with high probability.

To explain the “Ensemble LSQ” terminology, recall from the above discussion that LSQ has a left-side function computed by the party who holds the private data (the first bullet from the LSQ discussion), and a right-side function computed by the party who holds the query (the second bullet from the LSQ discussion). The point here is that a single left-side function (the first bullet above) is compatible with an ensemble of right-side functions (the second bullet above, with any [symbol] ∈{1, . . . , L}, using the random Gaussian completions.

At the top of FIG. 6 is a solution that uses a separate LSQ data structure 602 for each sub-sequence length. The privacy budget is partitioned among them, leading to error blow-up proportional to the final sequence length. As shown in the middle of FIG. 6, Ensemble LSQ uses a single data structure 604 that can handle all sub-sequence lengths. No privacy budget partitioning is necessary, and no error blow-up occurs. At the bottom of FIG. 6 is an illustration of the Ensemble LSQ querying technique. When the query has a shorter sub-sequence length than the final sequence length, the missing blocks are padded with random Gaussian completions.

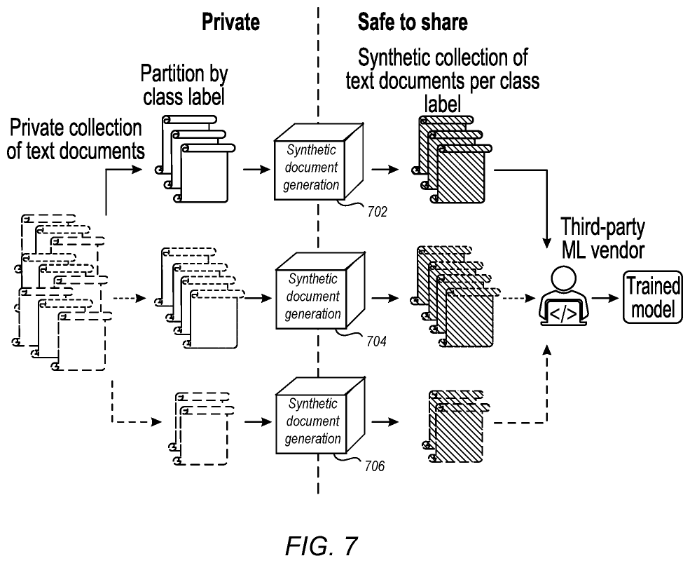

FIG. 7 illustrates a logical block diagram of generating keywords to produce synthetic documents that are used to train a model, according to some embodiments.

Suppose there exists a collection C of text documents, each labeled with one of m classes: 1) for every j=1, . . . , m, let Cⱼ⊂C denote the subset of documents with label j. For every sub-collection of documents Cⱼ with the same label, the party holding the private data (e.g., a hospital) constructs (702, 704, 706) a private synthetic collection of documents Ĉⱼ 2) Their union Ĉ=∪ⱼ₌₁^{m}Ĉⱼ is a synthetic labeled collection of documents, which satisfies differential privacy and can be safely shared externally, say with a third-party ML vendor. 3) The ML vendor trains a classifier on the synthetic labeled collection Ĉ 4) The model is provided back to the party holding the private data (the hospital), which can use it to classify new unseen text documents. In embodiments, to privately train a text classifier, for each class of documents, a synthetic collection of text documents is generated that preserves the key characteristics of that class, while being differentially private with respect to the original class documents.

FIG. 8 illustrates a high-level flowchart of various methods and techniques to implement generating keywords to produce synthetic documents while maintaining data privacy, according to some embodiments, according to some embodiments. As indicated at 810, synthetic documents may be generated using synthetic keywords to preserve privacy of original documents, in various embodiments. For example, a request sent from a client to a data management service/system may cause the generation of the synthetic documents (e.g., as discussed above with regard to FIG. 4).

In embodiments, the technique may be performed by a data management system and/or service (e.g., data management 210). This technique may, as indicated at 820, receive a DP-KDE distribution (e.g., from a client). The generation of the received DP-KDE distribution was based on vectors that respectively correspond to a different document of the original documents. Each vector may include a sequence of keywords extracted from a different document and then embedded into the vector.

As indicated at 830, the service may obtain a vector from the DP-KDE. The vector includes a sequence of synthetic keywords embedded into the vector. As noted herein, the sequence of synthetic keywords does not violate a data privacy restriction of the client for the original documents. In embodiments, the vector may be obtained using a score that is calculated at least in part on random Gaussian completions of the vector (e.g., selecting the highest scoring vector or selecting it from among a group of highest scoring vectors).

At block 840, the service decodes the vector into the sequence of synthetic keywords. At block 840, the service prompts a synthetic text generator (e.g., an LLM) to produce synthetic documents. The synthetic text generator is seeded with the sequence of synthetic keywords to produce the synthetic documents. At block 840, the service obtains the synthetic documents produced by the synthetic text generator. At block 840, the service stores the synthetic documents and/or sends the synthetic documents to an endpoint (e.g., to a remote network of the client).

In some embodiments, the system/service may receive, via the interface from a client of the data management system, a request to generate the sequence of synthetic keywords and/or to generate the synthetic documents and in response, the system/service may generate the synthetic keywords and/or the synthetic documents as described herein. In some embodiments, to obtain the vector, the system/service may calculate a score for the vector and select the vector based on the calculated score (e.g., if the score is the highest of a group of vectors or is above a threshold value for the score). As mentioned above, in embodiments the system/service may calculate the score for the vector based at least on one or more random Gaussian completions associated with the particular vector (e.g., padding a data structure, as described above).

In embodiments, the system/service may send the synthetic documents to a remote network of the client (or other client) of the data management service, wherein the remote network includes a model that is configured to be trained using the one or more synthetic documents. In embodiments, the above process may be repeated any number of times to generate different sequences of synthetic keywords, where each sequence can be used to seed the synthetic text generator to produce a different set of documents.

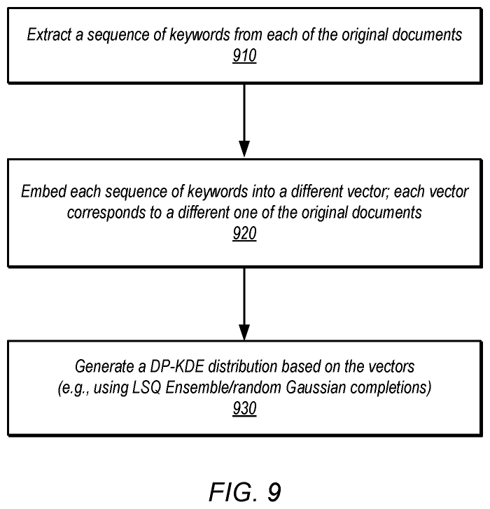

FIG. 9 illustrates a high-level flowchart of various methods and techniques to implement generating a DP-KDE distribution, according to some embodiments. In embodiments, the DP-KDE distribution (or other type of DP-DE distribution, as discussed above) may be generated by a privacy-preserving application, such as the privacy-preserving KDE client application of FIG. 3. As indicated at 910, the application may extract a sequence of keywords from each of the original documents. At 920, the application may embed each sequence of keywords into a different vector; each vector corresponds to a different one of the original documents. At 930, the application generates a DP-KDE distribution based on the vectors (e.g., using LSQ Ensemble/random Gaussian completions, as discussed herein).

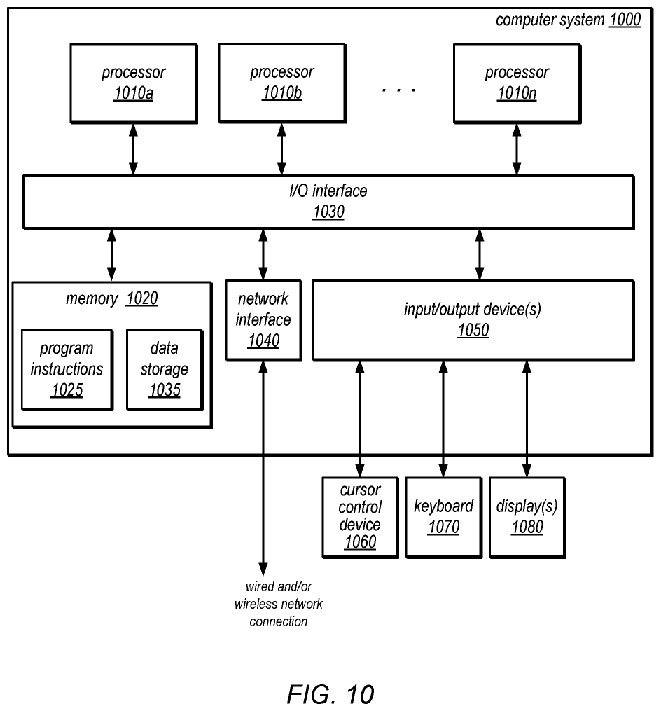

The methods described herein may in various embodiments be implemented by any combination of hardware and software. For example, in one embodiment, the methods may be implemented on or across one or more computer systems (e.g., a computer system as in FIG. 10) that includes one or more processors executing program instructions stored on one or more computer-readable storage media coupled to the processors. The program instructions may implement the functionality described herein (e.g., the functionality of various servers and other components that implement the network-based virtual computing resource provider described herein). The various methods as illustrated in the figures and described herein represent example embodiments of methods. The order of any method may be changed, and various elements may be added, reordered, combined, omitted, modified, etc.

Embodiments of generating keywords to produce synthetic documents while maintaining data privacy as described herein may be executed on one or more computer systems, which may interact with various other devices. One such computer system is illustrated by FIG. 10. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing device, computing node, compute node, or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. Display(s) 1080 may include standard computer monitor(s) and/or other display systems, technologies or devices. In at least some implementations, the input/output devices 1050 may also include a touch- or multi-touch enabled device such as a pad or tablet via which a user enters input via a stylus-type device and/or one or more digits. In some embodiments, it is contemplated that embodiments may be implemented using a single instance of computer system 1000, while in other embodiments multiple such systems, or multiple nodes making up computer system 1000, may host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, graphics rendering may, at least in part, be implemented by program instructions that execute on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a non-transitory, computer-readable storage medium may include storage media or memory media such as magnetic or optical media, e.g., disk or CD/DVD-ROM coupled to computer system 1000 via I/O interface 1030. Program instructions and data stored via a computer-readable medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 8, memory 1020 may include program instructions 1025, that implement the various methods and techniques as described herein, and data storage 1035, comprising various data accessible by program instructions 1025. In one embodiment, program instructions 1025 may include software elements of embodiments as described herein and as illustrated in the Figures. Data storage 1035 may include data that may be used in embodiments. In other embodiments, other or different software elements and data may be included.

Those skilled in the art will appreciate that computer system 1000 is merely illustrative and is not intended to limit the scope of the techniques as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a non-transitory, computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It is noted that any of the distributed system embodiments described herein, or any of their components, may be implemented as one or more web services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the web service in a manner prescribed by the description of the network-based service's interface. For example, the network-based service may describe various operations that other systems may invoke, and may describe a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a web services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, web services may be implemented using Representational State Transfer (“RESTful”) techniques rather than message-based techniques. For example, a web service implemented according to a RESTful technique may be invoked through parameters included within an HTTP method such as PUT, GET, or DELETE, rather than encapsulated within a SOAP message.

The various methods as illustrated in the FIGS. and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system, comprising:
at least one processor; and
a memory, storing program instructions that when executed by the at least one processor, cause the at least one processor to implement a data management system, configured to:
receive, from a client via an interface of the data management system, a differentially private density estimation (DP-DE) distribution,
wherein generation of the DP-DE distribution was based on a plurality of vectors that respectively correspond to a different document of a plurality of documents, and wherein a vector of the plurality of vectors comprises a sequence of keywords extracted from a given document of the plurality of documents and embedded into the vector;
obtain a particular vector from the DP-DE distribution, wherein the particular vector comprises a sequence of synthetic keywords embedded into the particular vector, and wherein the sequence of synthetic keywords does not violate a data privacy restriction of the client for the plurality of documents;
decode the particular vector into the sequence of synthetic keywords;
prompt a synthetic text generator to produce one or more synthetic documents, wherein the synthetic text generator is seeded with the sequence of synthetic keywords to produce the one or more synthetic documents;
obtain the one or more synthetic documents from the synthetic text generator; and
store the one or more synthetic documents or send the one or more synthetic documents to an endpoint.

2. The system of claim 1, wherein the data management system is further configured to:
receive, via the interface from a client of the data management system, a request to generate the one or more synthetic documents.

3. The system of claim 1, wherein to obtain a particular vector from the DP-DE distribution, the data management system is further configured to:
calculate a score for the particular vector from the DP-DE distribution; and
select the particular vector based on the calculated score.

4. The system of claim 3, wherein the DP-DE distribution is a differentially private kernel density estimation, and wherein to calculate the score for the particular vector, the data management system is further configured to:
calculate the score for the particular vector based at least on one or more random Gaussian completions associated with the particular vector.

5. The system of claim 1, wherein the data management system is further configured to provide to a remote computing system a privacy-preserving client application, wherein the privacy-preserving client application is configured to:
extract sequences of keywords from the plurality of documents;
embed the sequences of keywords into the plurality of vectors that respectively correspond to a different document of the plurality of documents; and
generate the DP-DE distribution based on the plurality of vectors.

6. A method, comprising:
performing, by a data management service implemented by one or more computing devices:
receiving, via an interface of the data management service, a differentially private kernel density estimation (DP-DE) distribution,
wherein generation of the DP-DE distribution was based on a plurality of vectors that respectively correspond to a different document of a plurality of documents, and wherein a vector of the plurality of vectors comprises a sequence of keywords extracted from a given document of the plurality of documents and embedded into the vector;
obtaining a particular vector from the DP-DE distribution, wherein the particular vector comprises a sequence of synthetic keywords embedded into the particular vector;
decoding the particular vector into the sequence of synthetic keywords; and
sending the sequence of synthetic keywords to an endpoint as a seed for a synthetic text generator to produce one or more synthetic documents.

7. The method of claim 6, wherein the endpoint comprises the synthetic text generator, and further comprising:
prompting the synthetic text generator to produce the one or more synthetic documents, wherein the synthetic text generator is seeded with the sequence of synthetic keywords to produce the one or more synthetic documents.

8. The method of claim 7, further comprising:
sending the one or more synthetic documents to a remote network of a client of the data management service, wherein the remote network comprises a model configured to be trained using the one or more synthetic documents.

9. The method of claim 6, further comprising receiving a request to generate the sequence of synthetic keywords or a request to generate the one or more synthetic documents.

10. The method of claim 6, wherein obtaining a particular vector from the DP-DE distribution comprises:
calculating a score for the particular vector from the DP-DE distribution; and
selecting the particular vector based on the calculated score.

11. The method of claim 10, wherein the DP-DE distribution is a differentially private kernel density estimation, and wherein calculating a score for the particular vector from the DP-DE distribution comprises:
calculating the score for the particular vector based at least on one or more random Gaussian completions associated with the particular vector.

12. The method of claim 10, wherein selecting the particular vector based on the calculated score comprises:
determining that the calculated score for the particular vector is among a group of highest scores calculated for a plurality of vectors from the DP-DE distribution.

13. The method of claim 6, further comprising:
obtaining a different vector from the DP-DE distribution, wherein the different vector comprises a sequence of different synthetic keywords embedded into the different vector;
decoding the different vector into the sequence of different synthetic keywords; and
sending the sequence of different synthetic keywords to the endpoint as a seed for the synthetic text generator to produce one or more different synthetic documents.

14. The method of claim 6, further comprising:
providing to a remote computing system, a privacy-preserving client application, wherein the privacy-preserving client application is configured to:
extract sequences of keywords from the plurality of documents;
embed the sequences of keywords into the plurality of vectors that respectively correspond to a different document of the plurality of documents; and
generate the DP-DE distribution based on the plurality of vectors.

15. One or more non-transitory, computer-readable storage media, storing program instructions that when executed on or across one or more computing devices cause the one or more computing devices to implement:
receiving a differentially private kernel density estimation (DP-DE) distribution,
wherein generation of the DP-DE distribution was based on a plurality of vectors that respectively correspond to a different document of a plurality of documents, and wherein a vector of the plurality of vectors comprises a sequence of keywords extracted from a given document of the plurality of documents and embedded into the vector;
obtaining a particular vector from the DP-DE distribution, wherein the particular vector comprises a sequence of synthetic keywords embedded into the particular vector, wherein the sequence of synthetic keywords does not violate a data privacy restriction for the plurality of documents;
decoding the particular vector into the sequence of synthetic keywords; and
sending the sequence of synthetic keywords to an endpoint as a seed for a synthetic text generator to produce one or more synthetic documents.

16. The one or more non-transitory, computer-readable storage media of claim 15, wherein the endpoint comprises a large language model (LLM) as the synthetic text generator, and wherein the one or more non-transitory, computer-readable storage media store further program instructions that when executed on or across the one or more computing devices, cause the one or more computing devices to further implement:
prompting the LLM to produce the one or more synthetic documents, wherein the LLM is seeded with the sequence of synthetic keywords to produce the one or more synthetic documents.

17. The one or more non-transitory, computer-readable storage media of claim 15, storing further program instructions that when executed on or across the one or more computing devices, cause the one or more computing devices to further implement receiving a request to generate the sequence of synthetic keywords or a request to generate the one or more synthetic documents.

18. The one or more non-transitory, computer-readable storage media of claim 15, wherein to obtain a particular vector from the DP-DE distribution, the program instructions when executed on or across the one or more computing devices, cause the one or more computing devices to further implement:
calculating a score for the particular vector from the DP-DE distribution; and
selecting the particular vector based on the calculated score.

19. The one or more non-transitory, computer-readable storage media of claim 18, wherein the DP-DE distribution is a differentially private kernel density estimation, and wherein to calculate a score for the particular vector from the DP-DE distribution, the program instructions when executed on or across the one or more computing devices, cause the one or more computing devices to further implement:
calculating the score for the particular vector based at least on one or more random Gaussian completions associated with the particular vector.

20. The one or more non-transitory, computer-readable storage media of claim 18, wherein to select the particular vector based on the calculated score, the program instructions when executed on or across the one or more computing devices, cause the one or more computing devices to further implement:
determining that the calculated score for the particular vector is among a group of highest scores calculated for a plurality of vectors from the DP-DE distribution.
